(19) United States
(12) Patent Application Publication
(10) Pub. No.: US 2009/0095418 A1
(43) Pub. Date: Apr. 16, 2009

(54) ULTRAVIOLET IRRADIATION METHOD AND APPARATUS USING THE SAME

(76) Inventors: Masayuki Yamamoto, Osaka (JP); Yukitoshi Hase, Kameyama-shi (JP); Takao Matsushita, Kameyama-shi (JP); Yasuji Kaneshima, Kameyama-shi (JP)

Correspondence Address: Cheng Law Group, PLLC, 1100 17th Street, N.W., Suite 503, Washington, DC, 20036, US

(21) Appl. No.: 12/242,453

(22) Filed: Sep. 30, 2008

(30) Foreign Application Priority Data
Oct. 10, 2007 (JP) 2007-264675

(51) Int. Cl. B29C 71/04

(52) U.S. Cl. 156/344; 156/584

(57) ABSTRACT

The ultraviolet ray is applied on the surface of the protective tape from an ultraviolet ray generator. In addition, the ultraviolet ray having intensity higher than that from the ultraviolet ray generator is applied on spot on the wafer edge by an irradiation gun. In this case, the ultraviolet ray intensity and the rotation speed of the holding table are controlled by a controller so that the ultraviolet irradiation amount per unit area of the wafer edge portion becomes equal to that to the joining surface of the protective tape.

### BACKGROUND OF THE INVENTION

(1) Field of the Invention

The present invention relates to an ultraviolet irradiation method and a device using the same for irradiating a protective tape with ultraviolet ray and lowering an adhesive force thereof before separating an ultraviolet curable protective tape joined to a surface of a semiconductor wafer.

(2) Description of the Related Art

A semiconductor wafer (hereinafter, simply referred to as “wafer”) is thinned by processing the back side of the wafer by using a mechanical method such as sharpening or grinding or a chemical method using etching. At the time of processing the wafer by using any of the methods, a protective tape is joined to a surface of the wafer to protect the surface on which a wiring pattern is formed. The wafer to which the protective tape is joined and which is grinded is arranged at the center of a ring frame, and a supporting adhesive tape is joined over the ring frame and the back side of the wafer. The protective tape is thereafter separated from the surface of the wafer held on the ring frame.

As a method for separating a protective tape as mentioned above, there is known a method for separating a separation tape integrally with a protective tape from a surface of a wafer by joining the separation tape of a strong adhesive force to the surface of the protective tape and separating the separation tape (see e.g., Japanese Laid-Open Patent Publication No. 5-63077).

The protective tape separating method described above uses the protective tape of ultraviolet curable type. That is, the separating process using the separation tape is performed after irradiating the entire protective tape with the ultraviolet ray and lowering the adhesive force of the protective tape. However, this method has the following problems.

In the process of joining the protective tape to the surface of the wafer, the protective tape is cut along the outer periphery of the wafer after joining the protective tape of a wider width than the diameter of the wafer to the entire wafer. The adhesive of the protective tape might run out to the wafer edge.

Even under the above sate, the adhesive that ran out from the wafer edge can be cured and the adhesive force can be lowered by irradiating with the ultraviolet ray while purging an inert gas such as nitrogen. However, the purged inert gas may be released into the atmosphere in the working process and the concentration of the inert gas in the atmosphere will become higher if the ultraviolet processing is performed to a great amount of wafers.

Furthermore, if the protective tape is separated without the adhesive force of the portion that ran out in the adhesive lowered, excessive separating stress may be concentrated on the wafer edge thereby damaging the wafer, or the adhesive may remain on the wafer edge.

### SUMMARY OF THE INVENTION

An object of the present invention is to provide an ultraviolet irradiation method and a device using the same capable of evenly curing the adhesive of the ultraviolet curable protective tape to be in a state enabling the protective tape to be separated at satisfactory precision.

The inventors of the present invention carried out a thorough review to reliably cure the adhesive that ran out from the wafer and lower the adhesive force, and found the following.

The inventors repeated various experiments for curing the adhesive under a state where the adhesive is exposed to the atmosphere without purging inert gas. As a result, it was found that by locally irradiating the run out adhesive with ultraviolet ray of intensity higher than that to be applied on the adhesive covered with a base material of the protective tape, curing can be promoted same as the base material covered portion and the adhesive force can be lowered, whereby even adhesive strength can be obtained. Based on this finding, the inventors of the present invention were able to separate the protective tape without damaging the wafer nor remaining the adhesive on the wafer edge by joining the separation tape to the ultraviolet processed protective tape and separating the same.

In order to achieve the above object, the invention employs the following configuration.

There is provided an ultraviolet irradiation method for irradiating a protective tape with an ultraviolet ray and lowering an adhesive force of the protective tape before a separation process of the ultraviolet curable protective tape joined to a surface of a semiconductor wafer, the method including the step of irradiating with the ultraviolet ray a protective tape joining surface and a peripheral edge of the semiconductor wafer such that an irradiation intensity of the ultraviolet ray to the peripheral edge of the semiconductor wafer is higher than that to the protective tape joining surface.

According to the ultraviolet irradiation method of the present invention, since the ultraviolet ray of intensity higher than that applied to the entire surface of the tape is applied even when the adhesive runs out from the edge of the semiconductor wafer, all the adhesives can be cured substantially equally, and the adhesive force thereof can be lowered. Therefore, damages of the wafer, and remains of the adhesive at the wafer edge can be eliminated during the protective tape separation process in the post process.

In the method invention described above, an ultraviolet ray is preferably locally applied from an outer peripheral site of the semiconductor wafer towards the wafer edge, and the ultraviolet ray and the semiconductor wafer are relatively moved in a peripheral direction of the wafer.

According to this method, the ultraviolet ray of high intensity can be concentratedly applied on the adhesive at the peripheral edge of the protective tape or the adhesive that ran out from the wafer. That is, the above-described method can be suitably performed using this method.

In the method invention described above, an ultraviolet irradiation amount per unit area of the protective tape joining surface of the semiconductor wafer and an ultraviolet irradiation amount per unit area of a wafer edge are preferably the same.

According to this method, the separating stress during the separation of the protective tape becomes even, and damages of the semiconductor wafer can be avoided.

In the method invention described above, irradiation with the ultraviolet ray is preferably simultaneously performed on the protective tape joining surface and the wafer edge of the semiconductor wafer.

According to this method, the processing time can be reduced compared with the time for irradiating each irradiation site separately with the ultraviolet.

In the method invention described above, the semiconductor wafer is preferably mounted on a holding table in an alignment stage and the ultraviolet ray is applied on the wafer edge during the rotating operation for alignment.

The processing efficiency can be enhanced since the irradiation with the ultraviolet ray of the wafer edge can be performed at the same time as alignment.

Further, in order to achieve the above object, the invention employs the following configuration.

There is provided an ultraviolet irradiation device for irradiating a protective tape with an ultraviolet ray and lowering an adhesive force before a separation process of the ultraviolet curable protective tape joined to a surface of a semiconductor wafer, the unit including holding means for mounting and holding the semiconductor wafer with the protective tape joined thereto; main ultraviolet irradiation means for irradiating with the ultraviolet ray the surface of the protective tape from above the mounted and held semiconductor wafer; and auxiliary ultraviolet irradiation means for irradiating a peripheral edge of the protective tape with an ultraviolet ray of intensity higher than the ultraviolet ray applied on the surface of the tape.

According to this configuration, the ultraviolet ray of higher intensity can be concentratedly applied on the portion of the adhesive that ran out from the wafer edge than the intensity of the ultraviolet ray applied on the peripheral edge of the protective tape and the surface of the protective tape covered with base material. That is, the method described above can be suitably realized according to this configuration.

In the device invention described above, the auxiliary ultraviolet irradiation means is preferably configured with an irradiator for locally irradiating with an ultraviolet ray of high intensity from an outer peripheral site of the semiconductor wafer towards the wafer edge; and the device further includes scanning means for relatively moving the irradiator and the semiconductor wafer in a peripheral direction of the wafer.

According to this configuration, the ultraviolet ray of high intensity can be efficiently applied to the wafer edge without requiring large auxiliary ultraviolet irradiation means towards the entire periphery of the wafer edge. Therefore, the auxiliary ultraviolet irradiation means can be miniaturized and simplified.

The relevant device may adopt the following configurations.

Firstly, the main ultraviolet irradiation means includes a light shield hood whose opening diameter is larger than the diameter of the semiconductor wafer; the auxiliary ultraviolet irradiation means is arranged at a lower end of the light shield hood; and the device further includes a controller for lifting the main ultraviolet irradiation means and the light shield hood from a retreat position above the semiconductor wafer to an operating position where the lower end of the light shield hood is positioned at a surface height of the semiconductor wafer, and irradiating with the ultraviolet ray the wafer edge from the auxiliary ultraviolet irradiation means at the operating position.

Secondly, the main ultraviolet irradiation means includes a light shield hood whose opening diameter is larger than the diameter of the semiconductor wafer; and the device further includes a box light shielding wall including auxiliary ray irradiation means at the lower end while accommodating the main ultraviolet irradiation means and the light shield hood, and including a tubular movable light shielding wall that moves upward and downward between a retreat position above the semiconductor wafer and an operating position of irradiating the wafer edge with the ultraviolet ray; and a controller for lifting the main ultraviolet irradiation means and the light shield hood as well as the movable light shielding wall between the retreat position and the operating position, and irradiating with the ultraviolet ray the wafer edge from the auxiliary ultraviolet irradiation means at the operating position.

In the first and second configurations, the controller preferably simultaneously performs irradiation with the ultraviolet ray of the surface of the protective tape from the main ultraviolet irradiation means and irradiation with the ultraviolet ray of the wafer edge from the auxiliary ultraviolet irradiation means.

The irradiator may adopt the following configurations.

For instance, the irradiator and an ultraviolet ray generator are connected with an optical fiber.

According to this configuration, the ultraviolet ray generator can be easily arranged at any locations, and a weak ultraviolet ray can be easily converged to obtain an ultraviolet ray of a higher intensity and then applied.

Furthermore, the irradiator is configured by an ultraviolet emission diode.

According to this configuration, generation of heat can be suppressed while enhancing the intensity of the ultraviolet ray.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view illustrating a whole semiconductor wafer mount apparatus;

FIG. 2 is a longitudinal cross-sectional view showing a state where an irradiation gun of an ultraviolet irradiation device is operating;

FIG. 3 is a longitudinal cross-sectional view showing a state where an ultraviolet ray generator of the ultraviolet irradiation device is operating;

FIG. 4 is a perspective view showing the operation of a separation mechanism;

FIG. 5 is a longitudinal cross-sectional view showing another embodiment of the ultraviolet irradiation device;

FIG. 6 is a longitudinal cross-sectional view showing another embodiment of the ultraviolet irradiation device; and

FIG. 7 is an enlarged cross-sectional view of a wafer edge.

### DESCRIPTION OF THE PREFERRED EMBODIMENT

An embodiment of a semiconductor wafer mount apparatus of the present invention including an ultraviolet irradiation device of the present invention will be described with reference to the drawings.

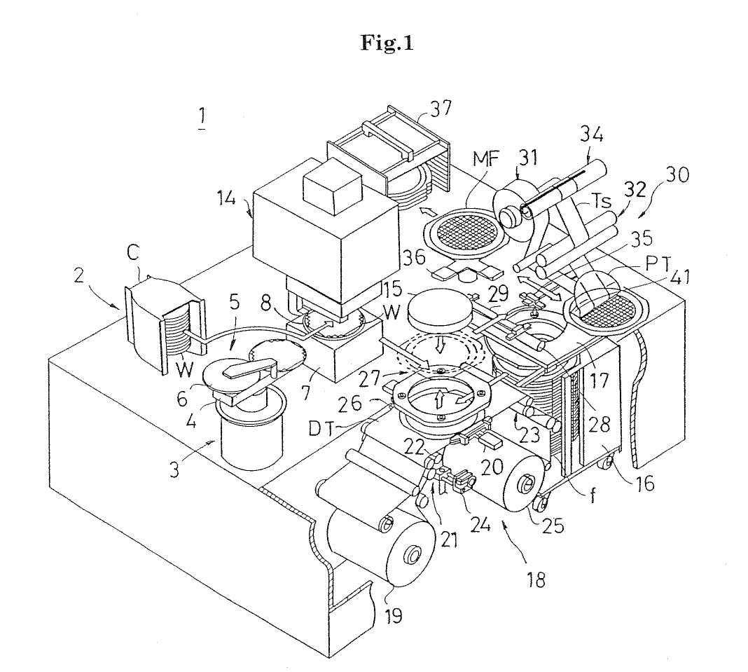

FIG. 1 is a cutaway perspective view illustrating a whole configuration of a semiconductor wafer mount apparatus according to one embodiment of the invention.

A semiconductor wafer mount apparatus 1 of the present embodiment includes a wafer supply part 2 in which cassette C for housing semiconductor wafers W (hereinafter, simply referred to as “wafer W”) subjected to a back grinding process in multiple stages are loaded, a wafer transport mechanism 3 having a robot arm 4 and a pressing mechanism 5, an alignment stage 7 for aligning the wafer W, an ultraviolet irradiation unit 14 for applying ultraviolet rays to the wafer W mounted on the alignment stage 7, a chuck table 15 for sucking and holding the wafer W, a ring frame supply part 16 in which ring frames f are housed in multiple stages, a ring frame transport mechanism 17 for moving to mount the ring frame f onto an adhesive tape DT serving as a dicing tape, a tape processing part 18 for joining the adhesive tape DT from the back side of the ring frame f, a ring frame lifting mechanism 26 for moving the ring frame f to which the adhesive tape DT is joined in the vertical direction, a mount frame fabrication part 27 for fabricating a mount frame MF integrated by joining the wafer W to the ring frame f to which the adhesive tape DT is joined, a first mount frame transport mechanism 29 for transporting the fabricated mount frame MF, a separation mechanism 30 for separating the protective tape PT joined to the surface of the wafer W, a second mount frame transport mechanism 35 for transporting the mount frame MF from which the protective tape PT is separated by the separation mechanism 30, a turn table 36 for rotating and transporting the mount frame MF, and a mount frame collecting part 37 for housing the mount frames MF in multiple stages.

The wafer supply part 2 has a cassette stand (not shown). The cassette C housing the wafers W, which has a protective tape PT joined to a pattern surface (hereinafter appropriately referred to as “surface”), in multiple stages is mounted on the cassette and. The wafer W maintains a horizontal posture with its pattern surface facing upward.

The wafer transport mechanism 3 is constructed so as to swing and move in the vertical direction by a driving mechanism (not shown). Specifically, the wafer transport mechanism 3 performs position adjustment of a wafer holder of the robot arm 4 that will be described later and a pressing plate 6 of the pressing mechanism 5, and transports the wafer W from the cassette C to the alignment stage 7.

The robot arm 4 of the wafer transport mechanism 3 has, at its distal end, a wafer holder (not shown) having a horseshoe shape. The robot arm 4 is constructed so that its wafer holder can move forward/rearward in the gaps between the wafers W housed in multiple stages in the cassette C. The wafer holder at the distal end of the robot arm has an suction hole and holds the wafer W at the distal end from the back side by vacuum.

The pressing mechanism 5 of the wafer transport mechanism 3 has, at its distal end, the circular pressing plate 6 having almost the same shape as that of the wafer W. The arm portion of the pressing mechanism 5 can move forward/rearward so that the pressing plate 6 is moved above the wafer W mounted on the alignment stage 7.

The pressing mechanism 5 operates in a case where poor suction occurs when the wafer W is mounted on a holding table 8 of the alignment stage 7 that will be described later. Concretely, when a warp occurs in the wafer W and the wafer W cannot be suction-held, the pressing plate 6 presses the surface of the wafer W and corrects the warp, so that the surface becomes flat. In this state, a holding table 8 sucks by vacuum the wafer W from the back side. The holding table 8 corresponds to the scanning means of the present invention.

The alignment stage 7 positions the mounted wafer W based on an orientation flat, a notch, or the like provided at the peripheral edge of the wafer W. The alignment stage 7 has the rotatable holding table 8 for covering and sucking by vacuum the whole back side of the wafer W.

The alignment stage 7 can transport the wafer W under a state where it suction-holds the wafer W between an initial position where the wafer W is mounted and positioned and an intermediate position between the chuck table 15 and the ring frame lifting mechanism 26 disposed in multiple stages above the tape processing part 18 that will be described later. That is, the alignment stage 7 transports the wafer W to the next process while correcting the warp of the wafer W and holding the wafer W under a flat state.

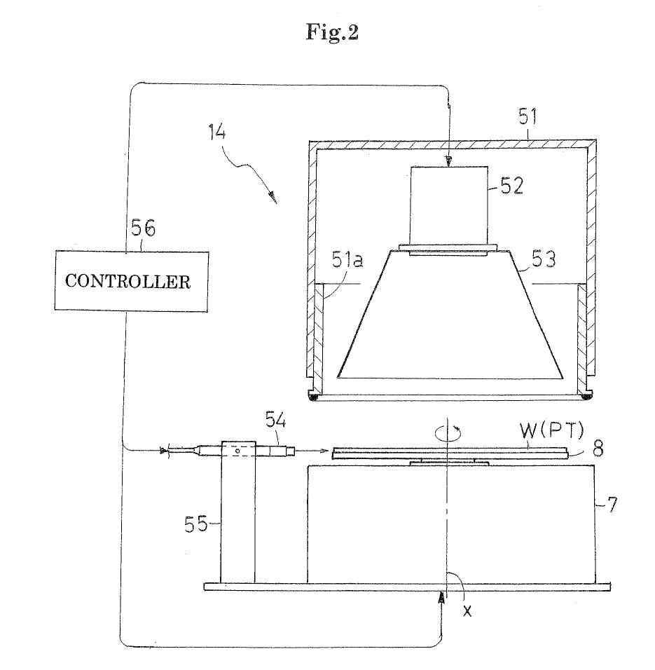

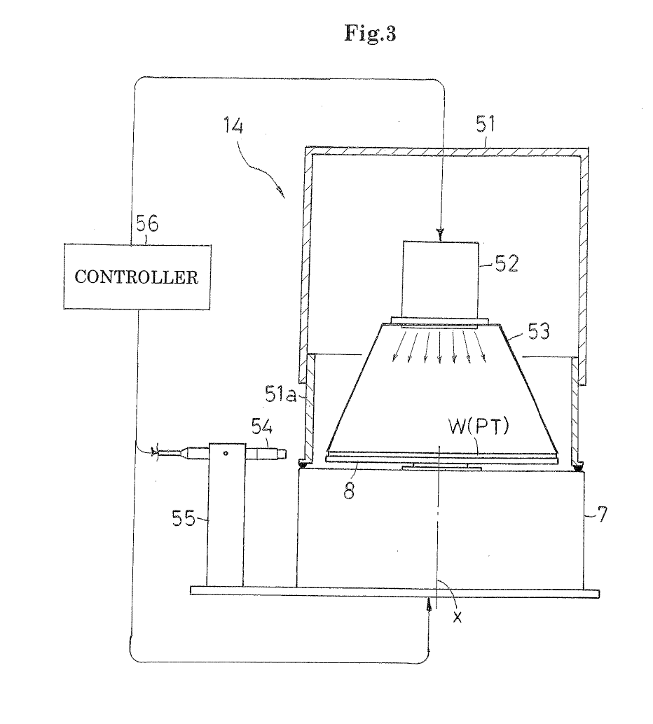

The ultraviolet irradiation device 14 is positioned above the alignment stage 7 in the initial position. The ultraviolet irradiation device 14 applies ultraviolet rays to the protective tape PT as an ultraviolet curing adhesive tape joined to the surface of the wafer W. In other words, the adhesive of the protective tape PT is cured by the irradiation with the ultraviolet ray thereby lowering the adhesive force. This structure is shown in FIGS. 2 and 3.

In other words, the ultraviolet irradiation device 14 includes a box light shielding wall 51 opened downward. An ultraviolet ray generator 52 and a light shielding hood 53 are arranged in the interior of the light shielding wall 51 in a lifting manner. An irradiation gun 54 is fixed on the alignment stage 7 side by way of a stator 55. The ultraviolet ray generator 52 corresponds to main ultraviolet irradiation means of the present invention, and the irradiation gun 54 corresponds to auxiliary ultraviolet irradiation means and an irradiator of the present invention.

A tubular movable light shielding wall 51a is arranged at the lower part of the light shielding wall 51 so as to be movable upward and downward. That is, as shown in FIG. 3, the movable light shielding wall 51a is moved downward until brought into contact with the upper surface of the alignment stage 7 to maintain air tightness in the interior of the light shielding wall in the process of performing ultraviolet irradiation from the ultraviolet ray generator 52.

The light shielding hood 53 is formed in a truncated conical shape spreading toward the bottom, where the diameter of the lower end thereof is set to a dimension slightly larger than the outer diameter of the wafer W. That is, when the light shielding hood 53 is moved downward along with the ultraviolet ray generator 52, the wafer W mounted and held on the holding table 8 of the alignment stage 7 is entirely covered with the light shielding hood 53. Therefore, the ultraviolet ray from the ultraviolet ray generator 52 is applied on the protective tape PT of the surface of the wafer without leaking the ray to the outside.

The irradiation gun 54 is installed so as to face the outer peripheral edge of the wafer W (wafer edge) mounted and held on the holding table 8 of the alignment stage 7 from right beside. In other words, the ultraviolet ray of a higher intensity is locally applied to the wafer edge from the irradiation gun 54. In the present embodiment, the irradiation gun 54 adopts a configuration of arranging the ultraviolet light emitting diode (hereinafter appropriately referred to as “ultraviolet LED”) and the ultraviolet ray generator at separated locations, and locally irradiating with the ultraviolet ray the wafer edge while guiding and condensing the ultraviolet ray from the device to the peripheral edge of the wafer W by means of an optical fiber.

The irradiation gun 54 and the ultraviolet ray generator 52 are connected to a controller 56. The controller 56 controls the ultraviolet irradiation intensity so as to be higher at the wafer edge portion than the surface of the wafer W. That is, the respective ultraviolet intensity and the irradiation time are controlled so that the adhesive force becomes the same at the wafer edge portion and the surface of the wafer. For instance, the ultraviolet intensity and the irradiation time are controlled for the surface of the wafer. The ultraviolet intensity is adjusted, and the ultraviolet irradiation amount per unit area is also adjusted by controlling the rotation speed of the holding table 8 for the wafer edge portion.

Returning to FIG. 1, the chuck table 15 has a circular shape which is almost the same as that of the wafer W so as to cover and suck by vacuum the surface of the wafer W, and is able to move vertically from a standby position above the tape processing part 18 to a position where the wafer W is joined to the ring frame f. That is, the chuck table 15 comes into contact with the wafer W whose warp is corrected and held under a flat state by the holding table 8, and suction-holds the wafer W.

The chuck table 15 moves downward to a position where it is fit in an opening of the ring frame lifting mechanism 26 for suction-holding the ring frame f, to which the adhesive tape DT to be described later is joined from the back side, and the wafer W comes close to the adhesive tape DT placed in the center of the ring frame f. At this time, the chuck table 15 and the ring frame lifting mechanism 26 are held by a holding mechanism (not shown).

The ring frame supply part 16 has a wagon shape having a bottom provided with wheels, and is loaded inside the device main body. The upper part of the ring frame supply part 16 is opened so that the ring frames f interiorly housed in multiple stages can be slid up and fed out.

The ring frame transport mechanism 17 sequentially sucks by vacuum the ring frames f housed in the ring frame supply part 16 from the top one by one, and transports the ring frame f in the order of the alignment stage (not shown) and a position where the adhesive tape DT is joined. The ring frame transport mechanism 17 also serves as a holding mechanism that holds the ring frame f in the position of joining the adhesive tape DT at the time of joining the adhesive tape DT.

The tape processing part 18 includes a tape supply part 19 for supplying the adhesive tape DT, a tension mechanism 20 for tensioning the adhesive tape DT, a joining unit 21 for joining the adhesive tape DT to the ring frame f, a cutter mechanism 24 for cutting the adhesive tape DT joined to the ring frame f, a separation unit 23 for separating an unnecessary tape from the ring frame f after the cutting by the cutter mechanism 24, and a tape collecting part 25 for collecting the cut unnecessary remaining tape.

The tension mechanism 20 catches both ends of the adhesive tape DT in the width direction and applies tension in the tape width direction. Specifically, when the soft adhesive tape DT is used, vertical wrinkles generate in the surface of the adhesive tape DT along the tape supply direction due to tension applied in the tape supply direction. In order to uniformly join the adhesive tape DT to the ring frame f while avoiding the vertical wrinkles, tension is applied from the tape width direction side.

The joining unit 21 is disposed in the standby position obliquely below (lower left in FIG. 1) the ring frame f held above the adhesive tape DT. A joining roller 22 provided in the joining unit 21 moves to the joining start position on the right side in the tape supply direction when the ring frame f held by the ring frame transport mechanism 17 is transported to the position where the adhesive tape DT is joined and supply of the adhesive tape DT from the tape supply part 19 starts.

The joining roller 22 arrived at the joining start position moves upward and presses and joins the adhesive tape DT against the ring frame f, and thereafter, rolls from the joining start position toward the standby position and joins the adhesive tape DT to the ring frame f while pressing the adhesive tape DT.

The separation unit 23 separates an unnecessary portion of the adhesive tape DT cut by the cutter mechanism 24 from the ring frame f. Concretely, after the adhesive tape DT is joined to the ring frame f and is cut, the holding of the adhesive tape DT by the tension mechanism 20 is released. The separation unit 23 moves toward the tape supply part 19 over the ring frame f to separate the cut unnecessary adhesive tape DT.

The cutter mechanism 24 is disposed below the adhesive tape DT on which the ring frame f is mounted. When the adhesive tape DT is joined to the ring frame f by the joining unit 21, the holding of the adhesive tape DT by the tension mechanism 20 is released. The cutter mechanism 24 thereafter moves upward. The cutter mechanism 24 thus moved upward cuts the adhesive tape DT along the ring frame f.

The ring frame lifting mechanism 26 is in a standby position above the position where the adhesive tape DT is joined to the ring frame f. The ring frame lifting mechanism 26 moves downward when the process of joining the adhesive tape DT to the ring frame f is finished, and suction-holds the ring frame f. At this time, the ring frame transport mechanism 17 that has held the ring frame f returns to the initial position above the ring frame supply part 16.

The ring frame lifting mechanism 26 suction-holds the ring frame f and moves upward to the position where the wafer W is joined to the ring frame f. At this time, the chuck table 15 that suction-holds the wafer W moves downward to the position where the wafer W is joined to the ring frame f.

The mount frame fabrication part 27 includes a joining roller 28 whose circumferential surface is elastically deformable. The joining roller 28 rolls while pressing a non-adhesion surface of the adhesive tape DT joined to the back side of the ring frame f.

The first mount frame transport mechanism 29 sucks by vacuum the mount frame MF integrally formed with the ring frame f and the wafer W, and moves the mount frame MF onto a separation table (not shown) of the separation mechanism 30.

The separation mechanism 30 includes a separation table (not shown) on which the wafer W is mounted and which moves the wafer W, a tape supply part 31 for supplying the separation tape Ts, a separation unit 32 for joining and separating the separation tape Ts, and a tape collecting part 34 for collecting the separated separation tape Ts and the protective tape PT.

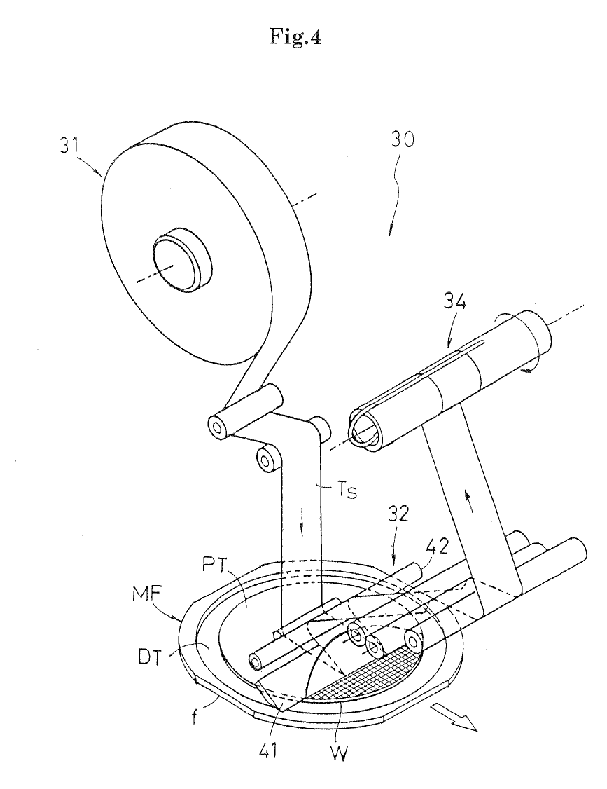

As shown in FIG. 4, the tape supply part 31 guides and supplies the separation tape Ts led from a separation tape roller to the lower end of the separation unit 32. The collecting part 34 guides the separation tape Ts fed from the separation unit 32 to the upper side, and then winds and collects the tape.

The separation unit 32 includes an edge member 41, which has a sharp distal end, as a joining member and a separation member of the separation tape Ts, and a feeding guide roller 42 for guiding the separation tape Ts folded back by the distal end of the edge member 41 towards the tape collecting part 34.

Referring again to FIG. 1, the second mount frame transport mechanism 35 sucks by vacuum the mount frame MF ejected from the separation mechanism 30, and moves it to the turn table 36.

The turn table 36 positions the mount frame MF and houses the mount frame MF into the mount frame collecting part 37. To be specific, when the mount frame MF is mounted on the turn table 36 by the second mount frame transport mechanism 35, the mount frame MF is positioned based on the orientation flat of the wafer W, the positioning shape of the ring frame f, and the like. The turn table 36 is rotated to change the direction of housing the mount frame MF into the mount frame collecting part 37. When the housing direction is determined, the turn table 36 pushes the mount frame MF by a pusher (not shown) to house the mount frame MF into the mount frame collecting part 37.

The mount frame collecting part 37 is mounted on a lifting mount table (not shown). By the vertical movement of the mount table, the mount frame MF pushed by the pusher can be housed in an arbitrary stage into the mount frame collecting part 37.

A series of operations will be described on the device according to the above embodiment.

The wafer holder of the robot arm 4 is inserted into the gaps in the cassette C. The wafer W is suction-held from below and pushed one by one. The ejected wafer W is transported to the alignment stage 7.

The wafer W is mounted on the holding table 8 by the robot arm 4 and suction-held from the back side thereof. At this time, the suction level of the wafer W is detected by a manometer (not shown), and is compared with a reference value predetermined with respect to a pressure value in normal operation.

When abnormality of suction is detected, the pressing plate 6 presses against the surface of the wafer W, and the wafer W is suction-held under a flat state obtained by correcting the warp. The wafer W is positioned based on an orientation flat or a notch.

The ultraviolet ray of a spot diameter is locally applied from the irradiation gun 54 to the wafer edge during the rotating operation of the holding table 8 in detecting the orientation flat and the notch of the wafer W. As shown in FIG. 2, with the movable light shielding wall 51a moved upward and the upper side of the alignment stage 7 opened, the ultraviolet ray is locally applied on spot from the irradiation gun 54 to the outer peripheral edge of the wafer W (wafer edge) mounted and held on the holding table 8. At the same time, the holding table 8 is rotated at a predetermined speed about the of the holding table 8, and the ultraviolet ray of intensity higher than the ultraviolet ray to be applied on the surface of the wafer W is locally applied onto the entire periphery of the outer peripheral edge of the wafer W. The adhesive of the protective tape PT facing the wafer edge is thereby cured, and the adhesive force thereof is lowered. The spot diameter and the intensity of the ultraviolet ray emitted from the irradiation gun 54 are appropriately changed according to the type of ultraviolet curable adhesive to be used, etc.

After alignment on the alignment stage 7 and the ultraviolet irradiation of the wafer edge are terminated, the ultraviolet irradiation of the surface of the wafer W is performed by the ultraviolet irradiation device 14 in the following manner.

As shown in FIG. 3, the movable light shielding wall 51a is moved downward until brought into contact with the upper surface of the alignment stage 7. Thereafter, the ultraviolet ray generator 52 and the light shielding hood 53 are moved downward, and the ultraviolet ray from the ultraviolet ray generator 52 is applied on the entire surface of the protective tape PT on the surface of the wafer while covering the wafer W. The adhesive of the portion covered with the base material of the protective tape PT is thereby cured and the adhesive force thereof is lowered.

After the ultraviolet irradiation process is performed, the wafer W is transported to the next mount frame fabrication part 27 with the alignment stage 7 while being sucked and held by the holding table 8. The alignment stage 7 moves to an intermediate position between the chuck table 15 and the ring frame lifting mechanism 26.

When the alignment stage 7 waits in a predetermined position, the chuck table 15 positioned above moves downward, the bottom face of the chuck table 15 comes into contact with the wafer W, and the chuck table 15 starts sucking the wafer W by vacuum. When the vacuum-suction of the chuck table 15 is started, the suction-holding on the holding table 8 side is released, and the wafer W is received by the chuck table 15 under a flat state where the warp is corrected. The alignment stage 7 that has delivered the wafer W returns to the initial position.

The ring frames f housed in multiple stages in the ring frame supply part 16 are sucked by vacuum and ejected one by one from the top by the ring frame transport mechanism 17. The ejected ring frame f is positioned on an alignment stage (not shown) and, after that, is transported to the adhesive tape DT joining position above the adhesive tape DT.

When the ring frame f is held by the ring frame transport mechanism 17 and is in the adhesive tape DT joining position, supply of the adhesive tape DT from the tape supply part 19 starts. Simultaneously, the joining roller 22 moves to the joining start position.

When the joining roller 22 arrives at the joining start position, the tension mechanism 20 holds both ends in the width direction of the adhesive tape DT and applies tension in the tape width direction.

Next, the joining roller 22 moves upward to press the adhesive tape DT against the end of the ring frame f and join it. After joining the adhesive tape DT to the end of the ring frame f, the joining roller 22 rolls toward the tape supply part 19 side as the standby position. At this time, the joining roller 22 rolls while pushing the adhesive tape DT from the non-adhesion surface to thereby join the adhesive tape DT to the ring frame f. When the joining roller 22 reaches the terminating end of the joining position, holding of the adhesive tape DT by the tension mechanism 20 is released.

Simultaneously, the cutter mechanism 24 moves upward to cut the adhesive tape DT along the ring frame f. After completion of cutting of the adhesive tape DT, the separation unit 23 moves toward the tape supply part 19 side and separates the unnecessary adhesive tape DT.

Thereafter, the tape supply part 19 operates to feed the adhesive tape DT and the unnecessary portion of the cut tape is sent to the tape collecting part 25. At this time, the joining roller 22 moves to the joining start position so as to join the adhesive tape DT to the next ring frame f.

The frame portion of the ring frame f to which the adhesive tape DT is joined is suction-held by the ring frame lifting mechanism 26 and is moved upward. At this time, the chuck table 15 also moves downward. That is, the chuck table 15 and the ring frame lifting mechanism 26 move to the position where the wafer W is joined.

The mechanisms 15 and 26 arrive at predetermined positions and are held by holding mechanisms (not shown). Next, the joining roller 28 moves to the joining start position of the adhesive tape DT, and rolls while pressing the non-adhesion surface of the adhesive tape DT joined to the bottom face of the ring frame f, thereby joining the adhesive tape DT to the wafer W. As a result, the mount frame MF obtained by integrating the ring frame f and the wafer W is fabricated.

After the mount frame MF is fabricated, the chuck table 15 and the ring frame lifting mechanism 26 move upward. At this time, a holding table (not shown) moves to a position below the mount frame MF, and the mount frame MF is mounted on the holding table. The mounted mount frame MF is suction-held by the first mount frame transport mechanism 29 and moved onto the separation table 38.

The separation table with the mount frame MF mounted thereon moves forward towards the lower side of the separation unit 32. In this process, the front end edge of the protective tape PT is detected by the optical sensor, and the pulse motor is operation controlled so that the separation table moves forward from the detected position by a distance to the distal end position of the edge member 41 from the optical sensor known in advance of the pulse motor. The forward movement of the separation table is then once stopped. That is, the forward movement is automatically stopped once when the front end edge of the protective tape PT arrives at the position immediately below the distal end of the edge member 41.

When the separation table is once stopped, the pulse motor is operation controlled and the movable block is moved downward, and the edge member 41 is lowered while winded by the separation tape Ts supplied from the tape supply part 31. That is, the separation tape Ts is pressed against the upper surface of the front end of the protective tape PT at the distal end of the edge member 41 with a predetermined pressing force, and joined thereto.

After the joining of the separation tape Ts to the front end of the protective tape PT is completed, the separation table again starts to move forward with the separation tape Ts pressed against the protective tape PT with the edge member 41, and the separation tape Ts is winded towards the tape collecting part 34 at a speed synchronized with the movement speed of the separation table. The edge member 41 then presses the separation tape Ts against the protective tape PT at the surface of the wafer W and joins the separation tape to the protective tape PT. At the same time, the protective tape PT is separated from the surface of the wafer W along with the separation tape while separating the joined separation tape Ts.

At the time when the pulse motor is operation controlled so that the edge member 41 moves forward by a distance corresponding to the diameter of the wafer from the lowering operated separation tape joining start position, that is, at the time when the edge member 41 arrives at the back end edge of the protective tape PT and the protective tape PT is completely separated from the surface of the wafer, the edge member 41 is controlled for moving upward, and the separation unit 32 returns to the initial state.

The mount frame MF subjected to the process of separating the protective tape PT is moved to the standby position of the second mount frame transport mechanism 35 by the separation table 38.

The mount frame MF ejected from the separation mechanism 30 is moved onto the turn table 36 by the second mount frame transport mechanism 35. The moved mount frame MF is positioned based on the orientation flat or notch, and its housing direction is adjusted. After completion of the positioning and adjustment of the housing direction, the mount frame MF is pushed by the pusher and housed into the mount frame collecting part 37.

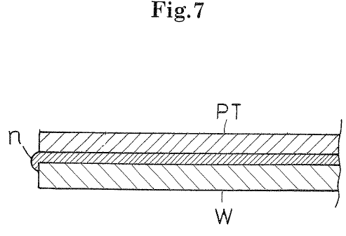

As described above, even when there is an adhesive that ran out from the wafer edge and is in contact with the atmosphere, the curing of the portion of the adhesive n that ran out shown in FIG. 7 is promoted by locally irradiating, with the ultraviolet ray of high intensity of a spot diameter, the wafer edge portion by the irradiation gun 54. Therefore, the adhesive that ran out can be cured at the same level as curing the adhesive of the portion covered with the base material by the ultraviolet ray applied on the surface of the wafer W from the ultraviolet ray generator 52.

In other words, the separating process of the protective tape can be carried out in the post-process while curing the adhesive force of all the adhesive existing on the wafer at the same level and maintaining the lowered adhesive force. As a result, the uncured adhesive does not exist on the wafer edge portion, and thus it will not be difficult to separate the protective tape PT. That is, since excessive separating stress is not applied onto the wafer edge portion, damages of the wafer can be avoided and the adhesive will not remain on the wafer edge portion.

Furthermore, ultraviolet ray does not need to be applied while purging inert gas.

The present invention is not limited to the above-described embodiment, but may be modified and implemented as follows.

(1) In the embodiment described above, the ultraviolet irradiation of the wafer in atmosphere is performed with the irradiation gun 54 arranged on the outer side of the lifting light shielding wall 51, but the following configurations may be adopted.

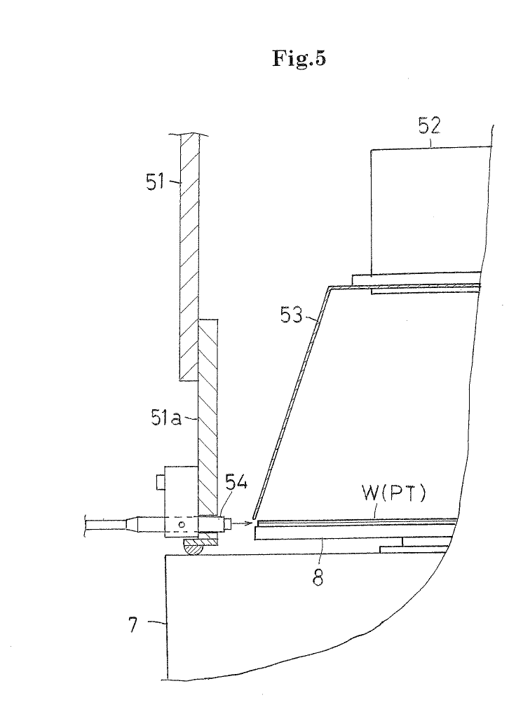

As shown in FIG. 5, the irradiation gun 54 is attached to the lower part of the light shielding wall 51. According to this configuration, the ultraviolet ray is locally applied on the wafer edge under a sealed state where the light shielding wall 51 is moved downward. That is, the irradiation of the surface of the wafer W and the irradiation of the wafer edge with the ultraviolet ray by the ultraviolet ray generator 52 can be simultaneously performed. In this case, the intensity and the time of the ultraviolet ray to be emitted from the ultraviolet ray generator 52 and the intensity of the ultraviolet ray to be emitted from the irradiation gun 54 as well as the rotation speed of the holding table 8 are controlled by the controller 56 so that the ultraviolet irradiation amount per unit area of the surface of the wafer W and the ultraviolet irradiation amount per unit area of the wafer edge become the same.

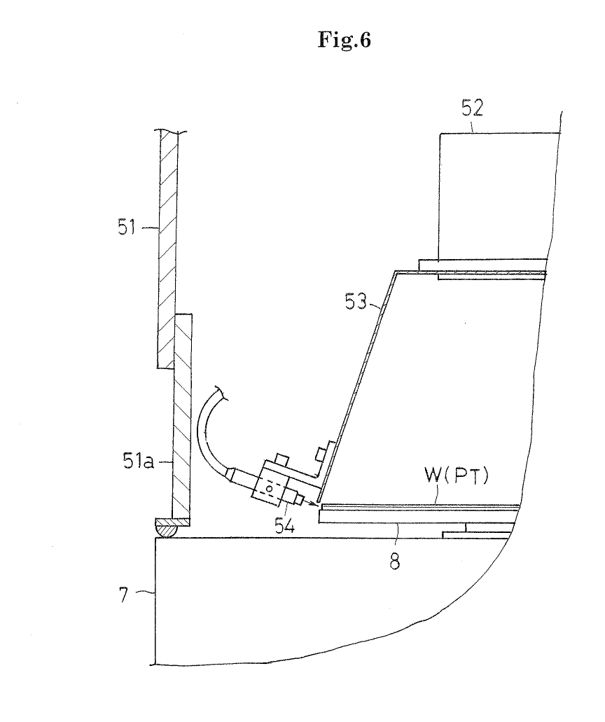

(2) As shown in FIG. 6, the ultraviolet ray may also be applied on spot on the wafer edge by attaching the irradiation gun 54 to the lower part of the light shielding hood 53.

(3) In the embodiment described above, the ultraviolet ray is applied on the entire periphery of the wafer edge by rotating the wafer W with respect to the irradiation gun 54 fixed at the position to perform spot irradiation with the ultraviolet ray. However, the wafer W may be fixed and the irradiation gun 54 may be rotated and scanned along the outer periphery of the wafer.

(4) The auxiliary ultraviolet irradiation means may be configured by annularly arranging a great number of ultraviolet ray generation lamps or ultraviolet LEDs toward the wafer edge so as to surround the wafer W.

(5) The ultraviolet ray by the irradiation gun 54, that is the auxiliary ultraviolet irradiation means, is preferably applied from right beside the wafer edge, but may be applied towards the wafer edge diagonally from above so that ultraviolet ray of high intensity is applied not only on the wafer edge but also on the predetermined range in the vicinity of the peripheral edge of the wafer.

(6) In the embodiment described above, the outer periphery of the wafer is light shielded by the movable light shielding wall 51a, but the ultraviolet ray may be applied on the surface of the protective tape PT from the ultraviolet ray generator 52 without the movable light shielding wall 51a.

(7) In the embodiment described above, the ultraviolet ray is applied on the entire surface of the protective tape PT after irradiating with the ultraviolet ray the outer peripheral edge of the wafer W, but may be carried out in the following manner. The irradiation with ultraviolet ray of both portions of the surface of the wafer W and the wafer edge may be simultaneously carried out, or the ultraviolet ray may be applied on the outer peripheral edge of the wafer W after irradiating with the ultraviolet ray the entire surface of the protective tape PT.

The present invention may be embodied in other specific forms without departing from the spirit or essential attributes thereof and, accordingly, reference should be made to the appended claims, rather than to the foregoing specification, as indicating the scope of the invention.

What is claimed is:

1. An ultraviolet irradiation method for irradiating a protective tape with an ultraviolet ray and lowering an adhesive force of the protective tape before a separation process of the ultraviolet curable protective tape joined to a surface of a semiconductor wafer, the method comprising the step of:
irradiating with the ultraviolet ray a protective tape joining surface and a peripheral edge of the semiconductor wafer such that an irradiation intensity of the ultraviolet ray to the peripheral edge of the semiconductor wafer is higher than that to the protective tape joining surface.

2. The ultraviolet irradiation method according to claim 1, wherein an ultraviolet ray is locally applied from an outer peripheral site of the semiconductor wafer towards the wafer edge, and the ultraviolet ray and the semiconductor wafer are relatively moved in a peripheral direction of the wafer.

3. The ultraviolet irradiation method according to claim 2, wherein an ultraviolet irradiation amount per unit area of the protective tape joining surface of the semiconductor wafer and an ultraviolet irradiation amount per unit area of the wafer edge are the same.

4. The ultraviolet irradiation method according to claim 1, wherein irradiation with the ultraviolet ray is simultaneously performed on the protective tape joining surface and the wafer edge of the semiconductor wafer.

5. The ultraviolet irradiation method according to claim 1, wherein the semiconductor wafer is mounted on a holding table of an alignment stage and the ultraviolet ray is applied on the wafer edge during rotating operation for alignment.

6. An ultraviolet irradiation device for irradiating a protective tape with an ultraviolet ray and lowering an adhesive force before a separation process of the ultraviolet curable protective tape joined to a surface of a semiconductor wafer, the device comprising:
holding means for mounting and holding the semiconductor wafer with the protective tape joined thereto;
main ultraviolet irradiation means for irradiating with the ultraviolet ray a surface of the protective tape from above the mounted and held semiconductor wafer; and
auxiliary ultraviolet irradiation means for irradiating a peripheral edge of the protective tape with an ultraviolet ray of intensity higher than the ultraviolet ray applied on the surface of the protective tape.

7. The ultraviolet irradiation device according to claim 6, wherein
the auxiliary ultraviolet irradiation means is configured with an irradiator for locally irradiating with an ultraviolet ray from an outer peripheral site of the semiconductor wafer towards the wafer edge; and the ultraviolet irradiation device further includes
scanning means for relatively moving the irradiator and the semiconductor wafer in a peripheral direction of the wafer.

8. The ultraviolet irradiation device according to claim 7, wherein
the main ultraviolet irradiation means includes a light shield hood whose opening diameter is larger than the diameter of the semiconductor wafer;
auxiliary ultraviolet irradiation means is arranged at a lower end of the light shield hood; and the ultraviolet irradiation device further includes
a controller for lifting the main ultraviolet irradiation means and the light shield hood from a retreat position above the semiconductor wafer to an operating position where the lower end of the light shield hood is positioned at a surface height of the semiconductor wafer, and irradiating with the ultraviolet ray the wafer edge from the auxiliary ultraviolet irradiation means at the operating position.

9. The ultraviolet irradiation device according to claim 8, wherein the controller simultaneously performs irradiation with the ultraviolet ray of the surface of the protective tape from the main ultraviolet irradiation means and irradiation with the ultraviolet ray of the wafer edge from the auxiliary ultraviolet irradiation means.

10. The ultraviolet irradiation device according to claim 7, wherein
the main ultraviolet irradiation means includes the light shield hood whose opening diameter is larger than the diameter of the semiconductor wafer; and the device further includes,
a box light shielding wall including auxiliary ray irradiation means at the lower end while accommodating the main ultraviolet irradiation means and the light shield hood, and including a tubular movable light shielding wall which moves upward and downward between the retreat position above the semiconductor wafer and the operating position of irradiating the wafer edge with the ultraviolet ray; and
a controller for lifting the main ultraviolet irradiation means and the light shield hood as well as the movable light shielding wall between the retreat position and the operating position, and irradiating with the ultraviolet ray the wafer edge from the auxiliary ultraviolet irradiation means at the operating position.

11. The ultraviolet irradiation device according to claim 10, wherein the controller simultaneously performs irradiation with the ultraviolet ray of the surface of the protective tape from the main ultraviolet irradiation means and irradiation with the ultraviolet ray of the wafer edge from the auxiliary ultraviolet irradiation means.

12. The ultraviolet irradiation device according to claim 6, wherein the irradiator and the ultraviolet ray generator are connected with an optical fiber.

13. The ultraviolet irradiation device according to claim 6, wherein the irradiator is configured by an ultraviolet emission diode.
